(19) United States
(12) Patent Application Publication
(10) Pub. No.: US 2026/0066288 A1
(43) Pub. Date: Mar. 5, 2026

(54) ELECTROCHEMICAL APPARATUS AND ELECTRONIC APPARATUS

(71) Applicant: Ningde Amperex Technology Limited, Ningde City (CN)

(72) Inventors: Junhua Jian, Ningde City (CN); Hui Cui, Ningde City (CN); Jianyu Liu, Ningde City (CN); Chao Tang, Ningde City (CN)

(73) Assignee: Ningde Amperex Technology Limited, Ningde City (CN)

(21) Appl. No.: 19/314,561

(22) Filed: Aug. 29, 2025

(30) Foreign Application Priority Data
Aug. 30, 2024 (CN) 202411209671.9

(51) Int. Cl. H01M 4/525; H01M 4/02; H01M 4/131; H01M 4/62; H01M 10/0525; H01M 10/0567; H01M 10/0568; H01M 10/0569

(52) U.S. Cl. CPC H01M 4/525; H01M 4/131; H01M 4/623; H01M 4/625; H01M 10/0525; H01M 10/0567; H01M 10/0568; H01M 10/0569; H01M 2004/028; H01M 2300/0028

(57) ABSTRACT

An electrochemical apparatus includes a positive electrode and a non-aqueous electrolyte, where the positive electrode includes a positive electrode material layer disposed on at least one surface of a positive electrode current collector, the positive electrode material layer includes a lithium-containing transition metal composite oxide, and the lithium-containing transition metal composite oxide includes LiₓNa_{z}Co_{1-y}M_{y}O₂, where 0.6<x<0.95, 0≤y<0.15, 0<z≤0.03, and M is at least one selected from a group consisting of Al, Mg, Ti, Mn, Fe, Ni, Zn, Cu, Nb, Cr, and Zr; and the non-aqueous electrolyte includes a compound of Formula I, a mass percentage of the compound of Formula I is A %, and 1≤A/z≤200.

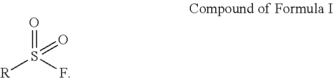

### CROSS REFERENCE TO THE RELATED APPLICATIONS

This application claims the benefit of priority from the Chinese Patent Application No. 202411209671.9, filed on Aug. 30, 2024, the entire content of which is incorporated herein by reference.

### TECHNICAL FIELD

This application relates to the field of energy storage technologies, and in particular, to an electrochemical apparatus and an electronic apparatus.

### BACKGROUND

With the increasing demand for electronic products such as mobile phones, notebook computers, and cameras, electrochemical apparatuses, as power sources for electronic products, play an increasingly important role in our daily lives, thus driving the need to improve the performance of electrochemical apparatuses in diverse scenarios. Existing technical approaches often lead to degradation of low-temperature discharge performance while improving the high-temperature performance of electrochemical apparatuses. Therefore, it is an urgent need to provide an electrochemical apparatus having good high-temperature performance and maintaining low-temperature discharge performance.

### SUMMARY

An embodiment of this application provides an electrochemical apparatus and an electronic apparatus, which can achieve superior high-temperature storage performance while improving low-temperature discharge performance and cycling performance.

According to a first aspect, an embodiment of this application provides an electrochemical apparatus including a positive electrode and a non-aqueous electrolyte, where the positive electrode includes a positive electrode material layer disposed on at least one surface of a positive electrode current collector, the positive electrode material layer includes a lithium-containing transition metal composite oxide, and the lithium-containing transition metal composite oxide includes LiₓNa_{z}Co_{1-y}MyO₂, where 0.6<x<0.95, 0≤y<0.15, 0≤z<0.03, and M is at least one selected from the group consisting of Al, Mg, Ti, Mn, Fe, Ni, Zn, Cu, Nb, Cr, and Zr; and the non-aqueous electrolyte includes a compound of Formula I.

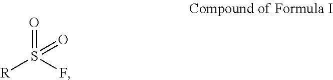

where R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, and substituents Ra of the groups are independently selected from fluorine or a C₁ to C₆ fluoroalkyl group; and based on a total mass of the non-aqueous electrolyte, a mass percentage of the compound of Formula I is A %, and 1<A/z<200.

Based on the electrochemical apparatus according to this embodiment of this application, the inventors have found that when the positive electrode material layer includes the lithium-containing transition metal composite oxide LiₓNa_{z}Co_{1-y}MyO₂ where the M element is at least one selected from Al, Mg, Ti, Mn, Fe, Ni, Zn, Cu, Nb, Cr, or Zr, the compound of Formula I is added to the non-aqueous electrolyte in the electrochemical apparatus, and the value of the mass percentage A of the compound of Formula I in the non-aqueous electrolyte and the value of z in a proportion of Na atoms in the lithium-containing transition metal composite oxide LiₓNa_{z}Co_{1-y}M_{y}O₂ are controlled to satisfy the above range, so that lone pair electrons in a sulfone functional group of the compound of Formula I can specifically bind to cobalt atoms and M atoms in the lithium-containing transition metal composite oxide LiₓNa_{z}Co_{1-y}M_{y}O₂, forming a highly stable inorganic-rich protective thin layer containing fluorides and sulfonate/sulfate during a battery formation process, thereby reducing interface impedance without affecting the high-temperature storage performance, facilitating lithium-ion interface transport at low temperatures, improving the low-temperature discharge performance of the electrochemical apparatus, and further facilitating the improvement in the stability of the positive electrode material layer under high-temperature conditions, and allowing the electrochemical apparatus to have excellent high-temperature storage performance.

In some embodiments, the mass percentage A % of the compound of Formula I in the electrochemical apparatus and a content z of Na in the lithium-containing transition metal composite oxide LiₓNa_{z}Co_{1-y}M_{y}O₂ satisfy at least one of the following conditions: (1) 5≤A/z≤100; (2) 0.1≤A≤5; or (3) 0.005≤z≤0.02. Based on the above embodiments, adjusting the mass percentage A % of the compound of Formula I and the content z of Na in the lithium-containing transition metal composite oxide to satisfy any one of the above conditions allows the lithium-containing transition metal composite oxide to better cooperate with the compound of Formula I in the electrolyte, allowing the sulfone functional group in the compound of Formula I to more completely bind to the cobalt atoms and M atoms in the lithium-containing transition metal composite oxide LiₓNa_{z}Co_{1-y}M_{y}O₂, thereby further improving the high-temperature storage performance and low-temperature discharge performance of the electrochemical apparatus.

In some embodiments, the compound of Formula I includes at least one of the following compounds:

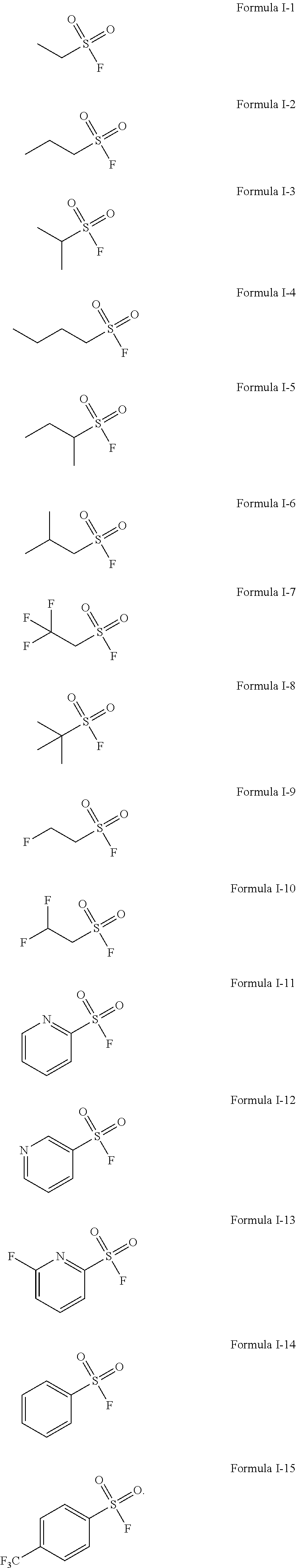

Based on the above embodiments, the above types of compounds of Formula I are selected, R groups in the structures can better facilitate the binding of the sulfone functional group with the cobalt atoms and M atoms in the lithium-containing transition metal composite oxide LiₓNa_{z}Co_{1-y}M_{y}O₂, thereby improving both the high-temperature storage performance and low-temperature discharge performance of the electrochemical apparatus.

In some embodiments, the non-aqueous electrolyte further includes a dinitrile substance represented by a compound of Formula II and a trinitrile substance represented by a compound of Formula III:

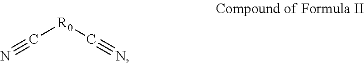

where R₀ is selected from a C₂ to C₁₀ chain alkylene group, a C₂ to C₁₀ alkenylene group, or —Rₐ—(O—R_{b})ₙ—R_{c}—, and Rₐ, R_{b}, and R_{c} are each independently selected from a C₁ to C₃ alkylene group or a C₂ to C₃ alkenylene group, and n is an integer from 1 to 3; and

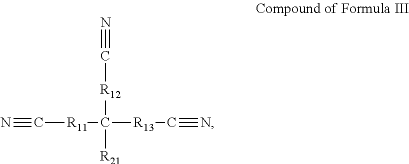

where R₁₁, R₁₂, and R₁₃ are each independently selected from a C₁ to C₃ alkylene group or —R_{A}—(O—R_{B})ₙ—R_{C}—, R_{A}, R_{B}, and R_{C} are each independently selected from a single bond or a C₁ to C₂ alkylene group, n is an integer from 1 to 3, and R₂₁ is selected from a hydrogen atom or a C₁ to C₃ alkylene group; where based on the total mass of the non-aqueous electrolyte, a mass percentage of the compound of Formula II is B %, a mass percentage of the compound of Formula III is C %, and 0.05≤A/(B+C)≤50. Based on the above embodiments, in the electrochemical apparatus of this application, specified percentages of the dinitrile substance and the trinitrile substance are added to the electrolyte. When controlled to satisfy 0.05≤A/(B+C)≤50, nitrile molecules in the dinitrile substance and the trinitrile substance can bind to the cobalt atoms in the lithium-containing transition metal composite oxide LiₓNa_{z}Co_{1-y}M_{y}O₂ in the positive electrode material layer, forming a cyanide-rich antioxidant coverage layer, and the combined use of the dinitrile substance and the trinitrile substance can further improve surface coverage, fully passivating a material interface, and effectively preventing electrolyte molecules from reaching the interface and undergoing continuous oxidation reactions, thereby further improving the high-temperature storage performance and low-temperature discharge performance of the electrochemical apparatus.

In some embodiments, for the mass percentage A % of the compound of Formula I, the mass percentage B % of the compound of Formula II, and the mass percentage C % of the compound of Formula III in the electrochemical apparatus satisfy at least one of the following conditions: (1) 0.5≤B+C≤8; (2) 0.1≤A/(B+C)≤2; (3) 0.1≤B≤6; or (4) 0.1≤C≤6. Based on the above embodiments, in the electrochemical apparatus of this application, controlling percentage parameters of the mass percentage A % of the compound of Formula I, the mass percentage B % of the compound of Formula II, and the mass percentage C % of the compound of Formula III within the above ranges allows the percentages of the compounds, especially the percentages of the dinitrile substance and the trinitrile substance, to be within appropriate ranges. This is more conducive to the synergistic effect of the dinitrile substance and the trinitrile substance, further improving surface coverage, and more fully passivating the material interface, thereby further improving the high-temperature storage performance and low-temperature discharge performance of the electrochemical apparatus.

In some embodiments, the compound of Formula II is at least one selected from succinonitrile, glutaronitrile, methyl glutaronitrile, adiponitrile, pimelonitrile, suberonitrile, trans-butenedinitrile, or 1,2-bis(cyanoethoxy)ethane.

In some embodiments, the compound of Formula III is at least one selected from 1,3,5-pentanetrinitrile, 1,3,6-hexanetrinitrile, or 1,2,3-tris(2-cyanoethoxy)propane. Selecting the above compound of Formula II and/or compound of Formula III can improve the binding efficiency of nitrile molecules with the cobalt atoms in the lithium-containing transition metal composite oxide LiₓNa_{z}Co_{1-y}M_{y}O₂ in the positive electrode material layer, improving surface coverage of the cyanide-rich antioxidant coverage layer, and more fully passivating the material interface, thereby further improving the high-temperature storage performance and low-temperature discharge performance of the electrochemical apparatus.

In some embodiments, the non-aqueous electrolyte further includes a cyclic carbonate; the cyclic carbonate is at least two selected from ethylene carbonate, propylene carbonate, or fluoroethylene carbonate; and based on the total mass of the non-aqueous electrolyte, a mass percentage of the cyclic carbonate is 1% to 30%. Preferably, the mass percentage of the cyclic carbonate is 2% to 15%. Based on the above embodiments, selecting the above cyclic carbonate in the electrolyte and controlling the percentage of the cyclic carbonate within the above range can further improve both the high-temperature storage performance and low-temperature discharge performance of the electrochemical apparatus.

In some embodiments, the non-aqueous electrolyte further includes a linear ester; the linear ester includes a fluorinated linear ester and a non-fluorinated linear ester; and the linear ester satisfies at least one of the following conditions: (1) the fluorinated linear ester is at least one selected from methyl difluoroethyl carbonate, methyl trifluoroethyl carbonate, ethyl trifluoroethyl carbonate, methyl hexafluoroisopropyl carbonate, bis(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate; (2) the non-fluorinated linear ester is at least one selected from dimethyl carbonate, ethyl methyl carbonate, methyl propyl carbonate, ethyl propyl carbonate, methyl acetate, ethyl acetate, propyl acetate, methyl propionate, ethyl propionate, or propyl propionate; or (3) based on the total mass of the non-aqueous electrolyte, a mass percentage of the linear ester is X₀%, and 10≤X₀≤70, preferably 15≤X₀≤50. Based on the above embodiments, selecting the linear ester including the fluorinated linear ester and the non-fluorinated linear ester in the electrolyte and controlling the percentage of the linear ester within the above ranges can further improve both the high-temperature storage performance and low-temperature discharge performance of the electrochemical apparatus.

In some embodiments, the mass percentage X₀% of the linear ester, the mass percentage X₁% of the fluorinated linear ester, and the mass percentage X₂% of the non-fluorinated linear ester in the non-aqueous electrolyte satisfy at least one of the following conditions: (1) 10≤X₁≤50; or (2) 5≤X₂≤50. Based on the above embodiments, in the electrochemical apparatus of this application, controlling the percentage parameters of the mass percentage X₁% of the fluorinated linear ester and the mass percentage X₂% of the non-fluorinated linear ester in the non-aqueous electrolyte within the above ranges allows the percentages of the compounds, especially the percentage of the fluorinated linear ester, to be within appropriate ranges. This is more conducive to further improving both the high-temperature storage performance and low-temperature discharge performance of the electrochemical apparatus.

In some embodiments, the non-aqueous electrolyte further includes a zwitterionic substance, specifically including a compound of Formula IV and/or a compound of Formula V:

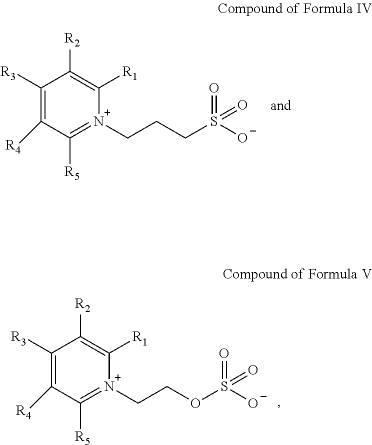

where R₁ to R₅ are each independently selected from a hydrogen atom, a fluorine atom, a vinyl group, an ethynyl group, or an anhydride group; based on the total mass of the non-aqueous electrolyte, a total mass percentage of the compound of Formula IV and the compound of Formula V is 0.1% to 1%; and any two adjacent groups among R₁ to R₅ exist independently or are connected through a covalent bond and connected to a patent ring to form a ring. Based on the above embodiments, in the electrochemical apparatus of this application, a specified percentage of zwitterionic substance is added to the electrolyte. The zwitterionic substance can complex transition metal ions dissolved from the lithium-containing transition metal composite oxide LiₓNa_{z}Co_{1-y}M_{y}O₂ and free in the electrolyte, significantly reducing the deposition of the transition metal ions on a negative electrode, and improving SEI stability, thereby improving the cycling performance, high-temperature storage performance, and low-temperature discharge performance of the electrochemical apparatus.

In some embodiments, the compound of Formula IV includes at least one of the following compounds:

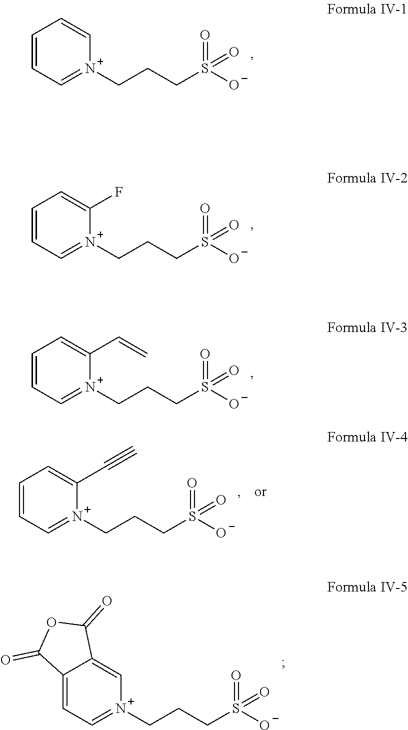 [SMILES: O=S(=O)([O-])CCC[n+]1ccccc1 ; O=S(=O)([O-])CCC[n+]1ccccc1F ; C=Cc1cccc[n+]1CCCS(=O)(=O)[O-] ; C#Cc1cccc[n+]1CCCS(=O)(=O)[O-] ; O=C1OC(=O)c2c[n+](CCCS(=O)(=O)[O-])ccc21]

and/or

the compound of Formula V includes at least one of the following compounds:

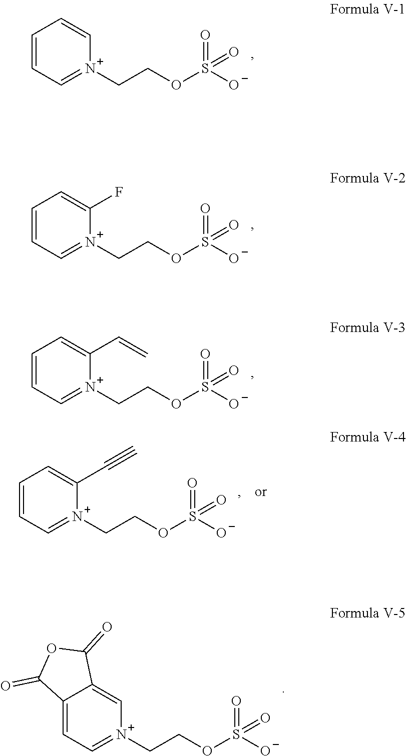 [SMILES: O=S(=O)([O-])OCC[n+]1ccccc1 ; O=S(=O)([O-])OCC[n+]1ccccc1F ; C=Cc1cccc[n+]1CCOS(=O)(=O)[O-] ; C#Cc1cccc[n+]1CCOS(=O)(=O)[O-] ; O=C1OC(=O)c2c[n+](CCOS(=O)(=O)[O-])ccc21]

Based on the above embodiments, selecting the above zwitterionic substance can more efficiently complex the transition metal ions dissolved from the lithium-containing transition metal composite oxide LiₓNa_{z}Co_{1-y}M_{y}O₂ and free in the electrolyte, reducing the deposition of the transition metal ions on the negative electrode, and improving SEI stability, thereby further improving the cycling performance, high-temperature storage performance, and low-temperature discharge performance of the electrochemical apparatus.

According to a second aspect, an embodiment of this application provides an electronic apparatus including the foregoing electrochemical apparatus.

### DETAILED DESCRIPTION

To make the objectives, technical solutions, and advantages of this application clearer and more comprehensible, the following further describes this application in detail with reference to some embodiments. It should be understood that the specific embodiments described herein are merely used to explain this application but are not intended to limit this application.

An embodiment of this application provides an electrochemical apparatus including a positive electrode, a non-aqueous electrolyte, a negative electrode, and a separator.

### Positive Electrode

The positive electrode includes a positive electrode current collector and a positive electrode material layer disposed on at least one surface of the positive electrode current collector. The positive electrode material layer includes a lithium-containing transition metal composite oxide. The lithium-containing transition metal composite oxide includes LiₓNa_{z}Co_{1-y}M_{y}O₂, where 0.6<x<0.95, 0≤y≤0.15, 0≤z≤0.03, and M is at least one selected from the group consisting of Al, Mg, Ti, Mn, Fe, Ni, Zn, Cu, Nb, Cr, and Zr. For example, the subscripts may satisfy: 0.6<x<0.7, 0≤y≤0.10, and 0<z<0.01; 0.7<x<0.8, 0.05<y<0.10, and 0<z<0.02; 0.8<x<0.9, 0.06<y<0.09, and 0<z≤0.03; 0.9<x<0.95, 0.07<y<0.08, and 0.01<z<0.02; or 0.6<x<0.9, 0.08<y<0.15, and 0.01<z≤0.03. Adding the above lithium-containing transition metal composite oxide to the positive electrode material layer of the electrochemical apparatus and controlling proportions of metal atoms in the lithium-containing transition metal composite oxide, especially a proportion of sodium atoms, to satisfy the above ranges can improve both the high-temperature storage performance and low-temperature discharge performance of the electrochemical apparatus.

In some embodiments, the positive electrode material layer includes a positive electrode conductive material; the type of the positive electrode conductive material is not limited, and any known conductive material may be used. Examples of the positive electrode conductive material may include but are not limited to: carbon black such as acetylene black and Super-P; carbon materials including amorphous carbon such as needle coke; carbon nanotubes; and graphene. The positive electrode conductive material may be used alone or in any combination.

In some embodiments, the positive electrode material layer includes a positive electrode binder; the type of the positive electrode binder is not particularly limited, and under a condition that a coating method is used, any material that can be dissolved or dispersed in a liquid medium used during electrode manufacturing may be used. Examples of the positive electrode binder may include but are not limited to one or more of the following: resin-based polymers such as polyethylene, polypropylene, polyethylene terephthalate, polymethyl methacrylate, polyimide, aromatic polyamide, cellulose, and nitrocellulose; rubber-like polymers such as styrene-butadiene rubber, nitrile rubber, fluororubber, isoprene rubber, polybutadiene rubber, and ethylene-propylene rubber; thermoplastic elastomeric polymers such as styrene-butadiene-styrene block copolymers or hydrides thereof, ethylene-propylene-diene terpolymers, styrene-ethylene-butadiene-ethylene copolymers, and styrene-isoprene-styrene block copolymers or hydrides thereof, soft resin-like polymers such as syndiotactic-1,2-polybutadiene, polyvinyl acetate, ethylene-vinyl acetate copolymers, and propylene-α-olefin copolymers; fluorinated polymers such as polyvinylidene fluoride, polytetrafluoroethylene, fluorinated polyvinylidene fluoride, and polytetrafluoroethylene-ethylene copolymers; and polymer compositions with ionic conductivity for alkali metal ions. The above positive electrode binders may be used alone or in any combination.

The type of a solvent used for forming a positive electrode slurry is not limited, provided that the solvent is capable of dissolving or dispersing a positive electrode active substance, a conductive material, a positive electrode binder, and a thickener used as appropriate to needs. Examples of the solvent used for forming the positive electrode slurry may include any one of an aqueous solvent or an organic solvent. Examples of the aqueous solvent may include but are not limited to a mixed solvent of alcohol and water or water. Examples of the organic solvent may include but are not limited to: aliphatic hydrocarbons such as hexane; aromatic hydrocarbons such as benzene, toluene, xylene, and methylnaphthalene; heterocyclic compounds such as quinoline and pyridine; ketones such as acetone, methyl ethyl ketone, and cyclohexanone; esters such as methyl acetate and methyl acrylate; amines such as diethylenetriamine and N,N-dimethylaminopropylamine; ethers such as diethyl ether, propylene oxide, and tetrahydrofuran; amides such as N-methylpyrrolidone, dimethylformamide, and dimethylacetamide; and aprotic polar solvents such as hexamethylphosphoramide and dimethyl sulfoxide.

The thickener is typically used to adjust the viscosity of the slurry. Under a condition that the aqueous solvent is used, the thickener and a styrene-butadiene rubber emulsion can be used for slurrying. The type of thickener is not particularly limited. Examples of the thickener may include but are not limited to carboxymethyl cellulose, methyl cellulose, hydroxymethyl cellulose, ethyl cellulose, polyvinyl alcohol, oxidized starch, phosphorylated starch, casein, and salts thereof. The above thickeners may be used alone or in any combination.

The type of the positive electrode current collector is not particularly limited, and any known material suitable for serving as a positive electrode current collector may be used. Examples of the positive electrode current collector may include but are not limited to: metal materials such as aluminum, stainless steel, nickel plating, titanium, and tantalum; and materials such as carbon cloth and carbon paper. In some embodiments, the positive electrode current collector is a metal material. In some embodiments, the positive electrode current collector is aluminum.

To reduce the electronic contact resistance between the positive electrode current collector and the positive electrode material layer, the surface of the positive electrode current collector may include a conductive additive or a conductive coating. Examples of the conductive additive may include but are not limited to carbon and noble metals such as gold, platinum, and silver. Examples of the conductive coating may include a mixture layer containing an inorganic oxide, a conductive agent, and a binder.

### Non-Aqueous Electrolyte

The non-aqueous electrolyte used in the electrochemical apparatus of this embodiment of this application includes an electrolytic salt and a solvent for dissolving the electrolytic salt. In some embodiments, the non-aqueous electrolyte of this application includes a compound of Formula I.

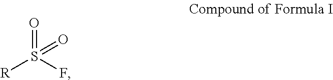

where R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, and substituents Ra of the groups are independently selected from fluorine or a C₁ to C₆ fluoroalkyl group. For example, R is selected from a C₂ alkyl group, a C₄ alkyl group, a C₆ alkyl group, a fluorine-substituted C₅ alkenyl group, a fluorine-substituted C₇ alkynyl group, a fluorine-substituted C₁₀ nitrogen-containing heteroaryl group, a C₂ fluoroalkyl-substituted C₆ alkyl group, or a C₂ fluoroalkyl-substituted C₁₂ aryl group.

In some embodiments, based on a total mass of the non-aqueous electrolyte, a mass percentage of the compound of Formula I is A %. The positive electrode material layer includes a lithium-containing transition metal composite oxide LiₓNa_{z}Co_{1-y}MyO₂, where 1≤A/z≤200. In some embodiments, 5≤A/z≤100. In some embodiments, 10≤A/z≤20. In some embodiments, 50≤A/z≤80. In some embodiments, 25≤A/z≤70. In some embodiments, 35≤A/z≤55. In some embodiments, 0.1≤A≤5. For example, A is 0.1, 0.2, 0.5, 1.0, 2.0, 2.5, 3.0, 4.0, 5.0, or a value within a range formed by any two of these values. In some embodiments, 0.005≤z≤0.03. For example, z is 0.005, 0.01, 0.015, 0.02, 0.023, 0.028, 0.03, or a value within a range formed by any two of these values. Adding the compound of Formula I to the non-aqueous electrolyte in the electrochemical apparatus and controlling the value of the mass percentage A of the compound of Formula I, the value of z in the lithium-containing transition metal composite oxide, and a ratio thereof to satisfy the above ranges can improve both the high-temperature storage performance of the electrochemical apparatus and the low-temperature discharge performance of the electrochemical apparatus.

In some embodiments, the compound of Formula I includes at least one of the following compounds:

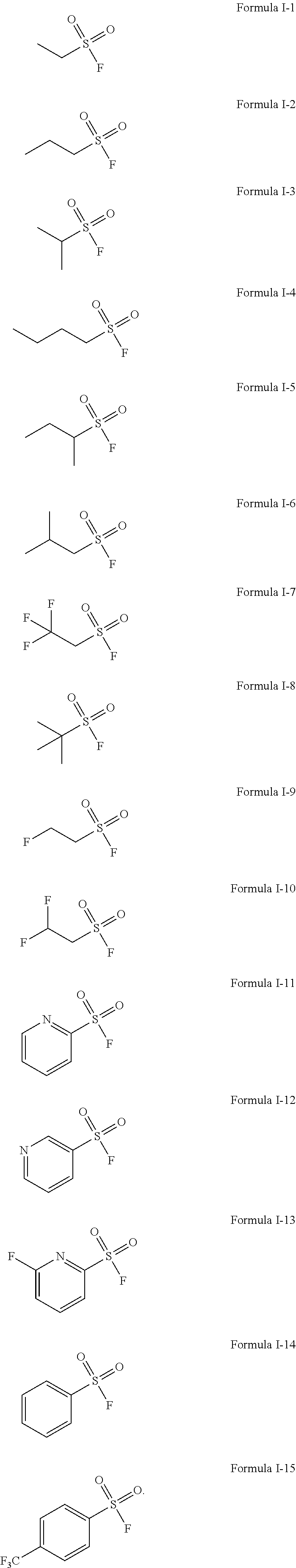

For example, the compound of Formula I is a mixture of a compound of Formula I-1, a mixture of compound of Formula I-8, a compound of Formula I-13, a compound of Formula I-2, and a compound of Formula I-7, a mixture of a compound of Formula I-4 and a compound of Formula I-11, or a mixture of a compound of Formula I-2 and a compound of Formula I-14. Selecting the above types of compounds of Formula I can improve both the high-temperature storage performance and low-temperature discharge performance of the electrochemical apparatus.

In some embodiments, the non-aqueous electrolyte further includes a dinitrile substance represented by a compound of Formula II and a trinitrile substance represented by a compound of Formula III:

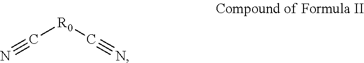

where R₀ is selected from a C₂ to C₁₀ chain alkylene group, a C₂ to C₁₀ alkenylene group, or —Rₐ—(O—R_{b})ₙ—R_{c}—, and Rₐ, R_{b}, and R_{c} are each independently selected from a C₁ to C₃ alkylene group or a C₂ to C₃ alkenylene group, and n is an integer from 1 to 3; and

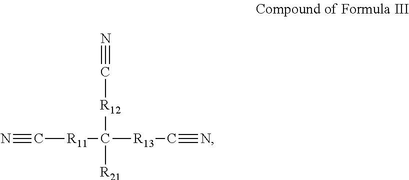

where R₁₁, R₁₂, and R₁₃ are each independently selected from a C₁ to C₃ alkylene group or —R_{A}—(O—R_{B})ₙ—R_{C}—, R_{A}, R_{B}, and R_{C} are each independently selected from a single bond or a C₁ to C₂ alkylene group, n is an integer from 1 to 3, and R₂₁ is selected from a hydrogen atom or a C₁ to C₃ alkylene group. In some embodiments, a mass percentage of the compound of Formula II is B %, a mass percentage of the compound of Formula III is C %, and 0.05≤A/(B+C)≤50. In some embodiments, 1≤A/(B+C)≤30. In some embodiments, 10≤A/(B+C)≤20. In some embodiments, 5≤A/(B+C)≤25. In some embodiments, 0.1≤A/(B+C)≤2. Adding the compound of Formula II and the compound of Formula III to the non-aqueous electrolyte in the electrochemical apparatus and controlling a ratio of a total mass percentage of the compound of Formula II and the compound of Formula III to the value of the mass percentage A of the compound of Formula I to satisfy the above ranges can improve both the high-temperature storage performance and low-temperature discharge performance of the electrochemical apparatus.

In some embodiments, the mass percentage B % of the compound of Formula II and the mass percentage C % of the compound of Formula III satisfy 0.5≤B+C≤8. In some embodiments, 2≤B+C≤8. In some embodiments, 5≤B+C≤7. In some embodiments, 4≤B+C≤6. In some embodiments, 0.5≤B+C≤3. In some embodiments, 0.1≤B≤6. For example, B is 0.1, 0.5, 1, 2, 3.5, 4, 6, or a value within a range formed by any two of these values. In some embodiments, 0.1≤C≤6. For example, C is 0.1, 0.3, 1, 2, 4, 5, 6, or a value within a range formed by any two of these values. Controlling the mass percentage B % of the compound of Formula II, the mass percentage C % of the compound of Formula III, and the total mass percentage thereof to satisfy the above ranges can improve both the high-temperature storage performance and low-temperature discharge performance of the electrochemical apparatus.

In some embodiments, the compound of Formula II is at least one selected from succinonitrile, glutaronitrile, methyl glutaronitrile, adiponitrile, pimelonitrile, suberonitrile, trans-butenedinitrile, or 1,2-bis(cyanoethoxy)ethane. In some embodiments, the compound of Formula III is at least one selected from 1,3,5-pentanetrinitrile, 1,3,6-hexanetrinitrile, or 1,2,3-tris(2-cyanoethoxy)propane. Selecting the above types of compounds of Formula II and compounds of Formula III can improve both the high-temperature storage performance and low-temperature discharge performance of the electrochemical apparatus.

In some embodiments, the non-aqueous electrolyte further includes a cyclic carbonate; the cyclic carbonate is at least two selected from ethylene carbonate, propylene carbonate, or fluoroethylene carbonate. In some embodiments, based on the total mass of the non-aqueous electrolyte, a mass percentage of the cyclic carbonate is 1% to 30%. In some embodiments, for example, the mass percentage of the cyclic carbonate is 2%, 5%, 10%, 17%, 22%, 29%, or a value within a range formed by any two of these values. In some embodiments, preferably, the mass percentage of the cyclic carbonate is 2% to 15%. Adding the cyclic carbonate to the non-aqueous electrolyte in the electrochemical apparatus and controlling the mass percentage of the cyclic carbonate to satisfy the above ranges can improve both the high-temperature storage performance and low-temperature discharge performance of the electrochemical apparatus.

In some embodiments, the non-aqueous electrolyte further includes a linear ester, the linear ester, where the linear ester includes a fluorinated linear ester and a non-fluorinated linear ester. The fluorinated linear ester is at least one selected from methyl difluoroethyl carbonate, methyl trifluoroethyl carbonate, ethyl trifluoroethyl carbonate, methyl hexafluoroisopropyl carbonate, bis(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate. The non-fluorinated linear ester is at least one selected from dimethyl carbonate, ethyl methyl carbonate, methyl propyl carbonate, ethyl propyl carbonate, methyl acetate, ethyl acetate, propyl acetate, methyl propionate, ethyl propionate, or propyl propionate. In some embodiments, based on the total mass of the non-aqueous electrolyte, a mass percentage of the linear ester is X₀%, and 10≤X₀≤70, preferably 15≤X₀≤50. For example, Xo is 10, 15, 25, 22, 31, 45, 50, 70, or a value within a range formed by any two of these values. Selecting the above types of linear esters and controlling the mass percentage of the linear ester in the non-aqueous electrolyte to satisfy the above ranges can improve both the high-temperature storage performance and low-temperature discharge performance of the electrochemical apparatus.

In some embodiments, a mass percentage of the fluorinated linear ester in the non-aqueous electrolyte is X₁%, and 10≤X₁≤0. For example, X₁ is 10, 12, 26, 35, 41, 47, 50, or a value within a range formed by any two of these values. In some embodiments, a mass percentage of the non-fluorinated linear ester is X₂%, and 5≤X₂≤50. For example, X₂ is 5, 9, 18, 24, 33, 40, 50, or a value within a range formed by any two of these values. Controlling the mass percentages of the fluorinated linear ester and non-fluorinated linear ester in the non-aqueous electrolyte to satisfy the above ranges can improve both the high-temperature storage performance and low-temperature discharge performance of the electrochemical apparatus.

In some embodiments, the non-aqueous electrolyte further includes a zwitterionic substance, specifically including a compound of Formula IV and/or a compound of Formula V:

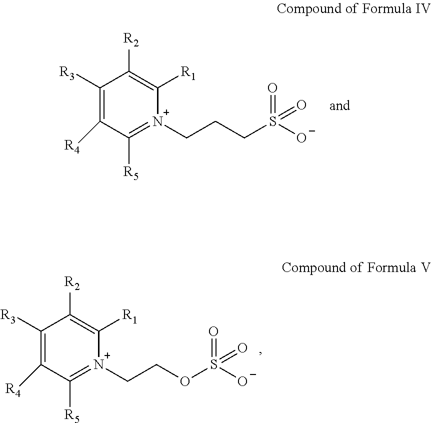

where R₁ to R₅ are each independently selected from a hydrogen atom, a fluorine atom, a vinyl group, an ethynyl group, or an anhydride group; and based on the total mass of the non-aqueous electrolyte, and a total mass percentage of the compound of Formula IV and the compound of Formula V is 0.1% to 1%. For example, the total mass percentage of the compound of Formula IV and the compound of Formula V is 0.1%, 0.3%, 0.5%, 0.6%, 0.9%, 1%, or a value within a range formed by any two of these values. In some embodiments, any two adjacent groups among R₁ to R₅ exist independently or are connected through a covalent bond and connected to a patent ring to form a ring. Selecting the above types of the compound of Formula IV and the compound of Formula V and controlling the total mass percentage of the compound of Formula IV and the compound of Formula V in the non-aqueous electrolyte to satisfy the above range can improve the high-temperature storage performance, low-temperature discharge performance, and cycling performance of the electrochemical apparatus.

In some embodiments, the compound of Formula IV includes at least one of the following compounds:

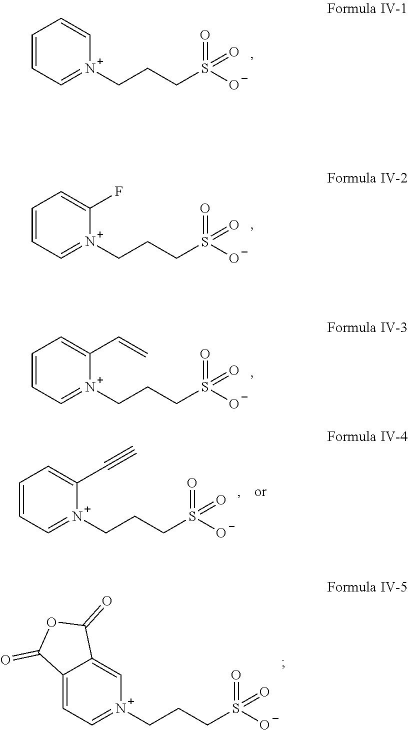 [SMILES: O=S(=O)([O-])CCC[n+]1ccccc1 ; O=S(=O)([O-])CCC[n+]1ccccc1F ; C=Cc1cccc[n+]1CCCS(=O)(=O)[O-] ; C#Cc1cccc[n+]1CCCS(=O)(=O)[O-] ; O=C1OC(=O)c2c[n+](CCCS(=O)(=O)[O-])ccc21]

and

the compound of Formula V includes at least one of the following compounds:

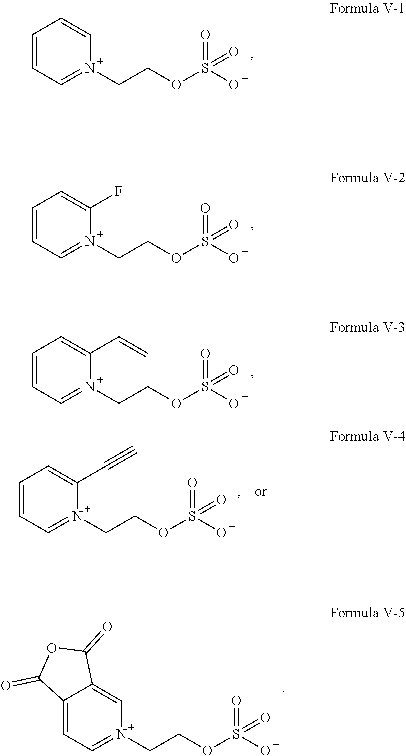 [SMILES: O=S(=O)([O-])OCC[n+]1ccccc1 ; O=S(=O)([O-])OCC[n+]1ccccc1F ; C=Cc1cccc[n+]1CCOS(=O)(=O)[O-] ; C#Cc1cccc[n+]1CCOS(=O)(=O)[O-] ; O=C1OC(=O)c2c[n+](CCOS(=O)(=O)[O-])ccc21]

Selecting the above types of compounds of Formula IV and compounds of Formula V can improve the high-temperature storage performance, low-temperature discharge performance, and cycling performance of the electrochemical apparatus.

The non-aqueous electrolyte may further include a lithium salt and a non-aqueous solvent. The type of the lithium salt is not particularly limited in this application, provided that the objective of this application can be achieved. For example, the lithium salt may include but is not limited to at least one of lithium hexafluorophosphate, lithium tetrafluoroborate, lithium difluorophosphate, lithium bis(trifluoromethanesulfonyl)imide, lithium bis(fluorosulfonyl)imide, lithium bis(oxalate)borate, or lithium difluoro(oxalate)borate. Based on the mass of the non-aqueous electrolyte, a mass percentage of the lithium salt may be 8% to 15%. For example, the mass percentage of the lithium salt may be 8%, 9%, 10%, 11%, 12.5%, 13%, 15%, or a range formed by any two of these values. The type of the non-aqueous solvent is not particularly limited in this application, provided that the objective of this application can be achieved. For example, the non-aqueous solvent may include but is not limited to at least one of an ether compound or another organic solvent. The ether compound may include but is not limited to at least one of ethylene glycol dimethyl ether, dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. The another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

### Negative Electrode

The negative electrode includes a negative electrode current collector and a negative electrode material layer disposed on at least one surface of the negative electrode current collector. The negative electrode material layer includes a negative electrode active material. In some embodiments, a rechargeable capacity of the negative electrode active material is greater than a discharge capacity of the positive electrode active material to prevent unintended precipitation of lithium metal on the negative electrode during charging.

The negative electrode active material may include at least one of natural graphite, artificial graphite, mesocarbon microbeads (MCMB), silicon, silicon-carbon composite, SiOₓ (0.5<x<1.6), Li—Sn alloy, Li—Sn—O alloy, Sn, SnO, SnO₂, lithium titanate Li₄Ti₅O₁₂ with a spinel structure, Li—Al alloy, or metallic lithium. Optionally, the negative electrode active material may further include an amorphous carbon material, and the amorphous carbon may be soft carbon (low-temperature calcined carbon), hard carbon, mesophase pitch carbide, or calcined coke.

The negative electrode material layer of this application further includes a negative electrode binder. The negative electrode binder can enhance binding between particles of the negative electrode active material and binding between the negative electrode active material and the current collector. The type of the negative electrode binder is not particularly limited, provided that the material is stable to the electrolyte or a solvent used during electrode manufacturing. In some embodiments, the negative electrode binder includes a resin binder. Examples of the resin binder include but are not limited to fluororesin, polyacrylonitrile (PAN), polyimide resin, acrylic resin, and polyolefin resin. When an aqueous solvent is used for preparing a negative electrode mixture slurry, the negative electrode binder includes but is not limited to carboxymethyl cellulose (CMC) or salts thereof, styrene-butadiene rubber (SBR), polyacrylic acid (PAA) or salts thereof, and polyvinyl alcohol.

The negative electrode material layer of this application further includes a conductive agent. The type of the negative electrode conductive agent is not particularly limited in this application, provided that the objective of this application can be achieved. For example, the negative electrode conductive agent may be at least one of acetylene black, Ketjen black, carbon nanotubes, carbon fiber, carbon dots, or graphene; and the carbon nanotubes may include but are not limited to at least one of single-walled carbon nanotubes or multi-walled carbon nanotubes.

The negative electrode current collector is not particularly limited in this application, provided that the objective of this application can be achieved. For example, the negative electrode current collector may include copper foil, aluminum foil, nickel foil, stainless steel foil, titanium foil, nickel foam, copper foam, or a polymer substrate coated with a conductive metal. The conductive metal includes but is not limited to copper, nickel, or titanium; and the material of the polymer substrate includes but is not limited to at least one of polyethylene, polypropylene, ethylene-propylene copolymers, polyethylene terephthalate, polyethylene naphthalate, or poly(p-phenylene terephthalamide). The thicknesses of the negative electrode current collector and the negative electrode material layer are not particularly limited in this application, provided that the objective of this application can be achieved. For example, the thickness of the negative electrode current collector is 4 μm to 12 μm, and the thickness of the negative electrode material layer on one surface is 30 μm to 160 μm. In this application, the negative electrode mixture layer may be disposed on one surface of the negative electrode current collector in its thickness direction or on both surfaces of the negative electrode current collector in its thickness direction. It should be noted that the “surface” herein may be an entire region of the negative electrode current collector or a partial region of the negative electrode current collector. This is not particularly limited in this application, provided that the objective of this application can be achieved.

A compacted density of the negative electrode plate is not particularly limited in this application, provided that the objective of this application can be achieved. For example, the compacted density of the negative electrode plate may be 1.0 g/cm³ to 1.85 g/cm³. A cold pressing pressure of the negative electrode plate is not particularly limited in this application, provided that the objective of this application can be achieved. For example, the cold pressing pressure of the negative electrode plate may be 3 tons to 30 tons.

Optionally, the negative electrode plate may further include a conductive layer, and the conductive layer is located between the negative electrode current collector and the negative electrode material layer. The composition of the conductive layer is not particularly limited in this application and may be a conductive layer commonly used in the art. The conductive layer includes a conductive agent and a binder. The conductive agent and binder in the conductive layer are not particularly limited in this application and may be at least one of the above conductive agents and binders. A mass ratio of the conductive agent to the binder in the conductive layer is not particularly limited in this application, and persons skilled in the art can select according to actual needs, provided that the objective of this application can be achieved. The thickness of the conductive layer is not particularly limited in this application, provided that the objective of this application can be achieved. For example, the thickness of the conductive layer is 1 μm to 10 μm.

### Separator

In this application, a separator is typically disposed between the positive electrode and the negative electrode, where the separator is configured to separate the positive electrode plate and the negative electrode plate, prevent internal short circuits of a secondary battery, and allow for free passage of electrolyte ions, without affecting an electrochemical charge and discharge process.

The separator is not particularly limited in this application, provided that the objective of this application can be achieved. For example, the material of the separator may include but is not limited to at least one of polyolefins (PO) mainly including polyethylene (PE) and polypropylene (PP), polyester (for example, a polyethylene terephthalate (PET) film), cellulose, polyimide (PI), polyamide (PA), spandex, or aramid. The type of separator may include at least one of a woven film, a non-woven film a microporous film, a composite film, a rolled film, or a spun film.

In this application, the separator may include a substrate and a surface treatment layer. The substrate may be a non-woven fabric or composite film with a porous structure, and the material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, the surface treatment layer is disposed on at least one surface of the substrate, and the surface treatment layer may be a polymer layer or an inorganic substance layer, or a layer formed by mixing a polymer and an inorganic substance. For example, the inorganic substance layer includes inorganic particles and a binder, and the inorganic particles are not particularly limited in this application. For example, the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited in this application. For example, the binder may be at least one of the foregoing binders. The polymer layer contains a polymer, and the material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

In this application, the separator has a pore size of 0.01 μm to 1 μm and a thickness of 5 μm to 50 μm. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the above range, insulation and mechanical strength can be ensured, and the rate performance and energy density of the secondary battery can be ensured.

The electrochemical apparatus of this application further includes a packaging bag for accommodating the positive electrode plate, the separator, the negative electrode plate, and the electrolyte, as well as other components known in the art in the electrochemical apparatus. The other components are not limited in this application. The packaging bag is not particularly limited in this application and may be a packaging bag known in the art, provided that the objective of this application can be achieved.

This application further provides an electronic apparatus including the electrochemical apparatus according to this embodiment of this application. The electronic apparatus includes but is not limited to a notebook computer, a pen-input computer, a mobile computer, an e-book player, a portable phone, a portable fax machine, a portable copier, a portable printer, a head-mounted stereo headphone, a video recorder, a liquid crystal display television, a portable cleaner, a portable CD player, a mini disc, a transceiver, an electronic notebook, a calculator, a memory card, a portable recorder, a radio, a backup power source, a motor, an automobile, a motorcycle, a motor bicycle, a bicycle, a lighting appliance, a toy, a game console, a timepiece, an electric tool, a flash lamp, a camera, a large household storage battery, or a lithium-ion capacitor.

### EXAMPLES

With a lithium-ion battery as an example, the following describes some embodiments of the secondary battery of this application more specifically by using examples and comparative examples. The preparation methods described in this application are only examples, and any other suitable preparation methods fall within the scope of this application. In addition, unless otherwise specified, “parts” and % are based on mass.

### Example 1-1

### <Preparation of Lithium-Ion Battery>

### (1) Preparation of Positive Electrode:

### <Preparation of Positive Electrode Active Material>

a. Cobalt nitrate and aluminum nitrate were dissolved in deionized water at a molar ratio of Co:Al=0.985:0.015, and a precipitant sodium carbonate and a complexing agent ammonia water were added until complete precipitation was achieved. Then, the resulting precipitate was sintered at 900° C. to 1100° C. and ground to obtain (Co_{0.985}Al_{0.015})₃O₄ powder. Ultimately, the (Co_{0.985}Al_{0.015})₃O₄ powder and Na₂CO₃ undergone reaction at a molar ratio of Al:Na=0.015:0.7 in an air atmosphere at 700° C. to 900° C. to obtain Na_{0.7}Co_{0.985}Al_{0.015}O₂.

b. Na_{0.7}Co_{0.985}Al_{0.015}O₂ obtained in step a was used as a precursor and mixed well with lithium nitrate at a molar ratio of Na:Li=0.01:0.01. The resulting mixture undergone reaction in an air atmosphere at 200° C. to 400° C. After the reaction was completed, the resulting reactant molten salt powder was washed multiple times with deionized water. After cleaned thoroughly, the molten salt powder was dried to obtain a positive electrode active material Li_{0.73}Na_{0.01}Co_{0.985}Al_{0.015}O₂.

### <Preparation of Positive Electrode Plate>

The positive electrode active material prepared in the above step, a conductive agent conductive carbon black, and polyvinylidene fluoride (PVDF) were mixed at a mass ratio of 95:2:3, and N-methylpyrrolidone (NMP) was added. Then, the resulting mixture was stirred well under the action of a vacuum mixer to obtain a positive electrode slurry with a solid content of 70 wt %. The positive electrode slurry was uniformly applied on one surface of a positive electrode current collector aluminum foil with a thickness of 9 μm, and drying was performed to obtain a positive electrode plate having one surface coated with a positive electrode mixture layer. The above steps were repeated on the other surface of the positive electrode current collector aluminum foil to obtain a positive electrode plate having both surfaces coated with the positive electrode mixture layer. After cold pressing, cutting, and slitting, drying was performed to obtain a positive electrode plate with dimensions of 74 mm×867 mm.

(2) Preparation of non-aqueous electrolyte: In a dry argon atmosphere glove box, diethyl carbonate was used as a base solvent, and then a compound of Formula I and lithium hexafluorophosphate (LiPF₆) were dissolved in the above base solvent, and vinylene carbonate was added as an additive to obtain an electrolyte. Based on a total mass of the electrolyte, a mass percentage of LiPF₆ was 12.5%, a mass percentage of vinylene carbonate was 2%, a mass percentage of the compound of Formula I was 0.1%, and the remainder was diethyl carbonate.

(3) Preparation of negative electrode: Artificial graphite is used as a negative electrode active material. The negative electrode active material, styrene-butadiene rubber (SBR), polyacrylic acid (PAA), carbon nanotubes (CNT), and carboxymethyl cellulose (CMC) were mixed at a mass ratio of 95.8:2.4:0.5:0.5:0.8, then deionized water was added as a solvent and stirred well to prepare a negative electrode slurry with a solid content of 45 wt %. The negative electrode slurry was uniformly applied on one surface of a negative electrode current collector copper foil with a thickness of 6 μm, and drying was performed to obtain a negative electrode plate having one surface coated with a negative electrode mixture layer. The above steps were repeated on the other surface of the negative electrode current collector copper foil to obtain a negative electrode plate having both surfaces coated with the negative electrode mixture layer. After cold pressing, cutting, and slitting, drying was performed to obtain a negative electrode plate with dimensions of 76.6 mm×875 mm.

(4) Preparation of separator: A porous polyethylene film with a thickness of 15 μm was used as a separator.

(5) Preparation of lithium-ion battery: The positive electrode plate, the separator, and the negative electrode plate were stacked sequentially, such that the separator is located between the positive electrode plate and the negative electrode plate to provide isolation. The resulting stack was wound to obtain a jelly roll. The jelly roll was placed in a packaging bag, the electrolyte was injected, and sealing was performed. After processes such as formation, degassing, trimming, and capacity testing, a lithium-ion battery was obtained.

### <Test Methods>

### (1) Test of Atomic Ratio of Lithium-Containing Transition Metal Composite Oxide in Positive Electrode Material Layer

The lithium-ion battery was disassembled to obtain a positive electrode plate, the positive electrode plate was cleaned with dimethyl carbonate (DMC), a positive electrode material layer of the cleaned positive electrode plate was scraped off with a scraper, 0.4 g of the positive electrode material layer was dissolved in a 10 mL mixed solvent of aqua regia (where nitric acid and hydrochloric acid were mixed at 1:1) and 2 mL HF, and diluted to 100 mL. Then, an ICP (Inductively Coupled Plasma, inductively coupled plasma) analyzer was used to test mass percentages of lithium, sodium, cobalt, and M elements, with the remaining mass recorded as a percentage of oxygen. Based on atomic masses of the elements, the mass percentages of the elements were correspondingly converted into molar percentages of the elements, and a molar percentage ratio of the elements was normalized to calculate corresponding values of x, y, and z. The value of z represented the number of sodium atoms in the lithium-containing transition metal composite oxide in the positive electrode material layer. With Li_{0.73}Na_{0.01}Co_{0.985}Al_{0.015}O₂ as an example, 0.4 g of the positive electrode material layer was dissolved in a 10 mL mixed solvent of aqua regia (where nitric acid and hydrochloric acid were mixed at 1:1) and 2 mL HF, and diluted to 100 mL. Then, an ICP analyzer was used to test mass percentages of lithium, sodium, cobalt, and aluminum elements as 52919 ppm, 2401 ppm, 606266 ppm, and 4227 ppm, respectively. The remaining mass was recorded as the mass of the oxygen element, with a mass percentage calculated as 1000000 ppm-(52919+2401+606266+4277) ppm=334187 ppm. The mass percentages were then divided by the atomic masses of the elements to obtain the molar ratios of the above elements as Li:Na:Co:Al:O=0.762:0.0104:1.029:0.0157:2.089. The value of the oxygen element was set to 2, and the above ratios were normalized to obtain Li:Na:Co:Al:O=0.73:0.01:0.985:0.015:2. That was, x=0.73; y=0.015; and z=0.01.

### (2) Test of High-Temperature Storage Performance:

The lithium-ion battery was placed in a constant-temperature environment at 25° C. and left standing for 30 min, such that the lithium-ion battery reached a constant temperature. The lithium-ion battery was charged to 4.5 V at a constant current of 0.5 C and then charged at a constant voltage of 4.5 V until the current was 0.025 C. The thickness of the battery was measured using a PPG pouch cell thickness gauge at a pressure of 700 g. Thicknesses at five different points in a non-tab position were measured, the thicknesses of the lithium-ion battery of five measurements were recorded, and an average of the five measurement values was recorded as an initial thickness. The lithium-ion battery was transferred to a thermostat at 60° C. and stored for 30 days. Then, the battery was taken out and cooled to room temperature. Thicknesses at five different points in the non-tab position were selected. A PPG pouch cell thickness gauge was used to measure and record the thickness of the battery after storage at a pressure of 700 g, and an average of the five measurement values was recorded as a storage thickness. A thickness swelling rate of the lithium-ion battery was calculated and used as an indicator to evaluate the high-temperature storage performance of the lithium-ion battery.

High-temperature storage thickness swelling rate=(storage thickness-initial thickness)/initial thickness×100%.

### (3) Test of Low-Temperature Discharge Performance:

A lithium-ion battery was placed in a high and low temperature chamber, the temperature was adjusted to 25° C., and the lithium-ion battery was left standing for 30 minutes, such that the lithium-ion battery reached a constant temperature. The lithium-ion battery with the constant temperature was discharged to 3.0 V at a constant current of 0.5 C, then charged to 4.5 V at a constant current of 0.5 C, and then charged at a constant voltage of 4.5 V until the current was 0.05 C. Likewise, at a temperature of 25° C., the lithium-ion battery was discharged to 3.0 V at a constant current of 0.5 C, and a discharge capacity at this point was recorded as an initial discharge capacity. At 25° C., the lithium-ion battery was charged to 4.5 V at a constant current of 0.5 C, and then charged at a constant voltage of 4.5 V until the current was 0.05 C. Then, the lithium-ion battery was placed at 0° C. and left standing for 30 minutes, such that the temperature of the lithium-ion battery was consistent with the external temperature. At 0° C., the lithium-ion battery was discharged to 3.0 V at a constant current of 0.5 C, and a discharge capacity at this point was recorded as a low-temperature discharge capacity.

Low-temperature discharge capacity retention rate=(low-temperature discharge capacity/initial discharge capacity)×100%.

### (4) Test of Cycling Performance:

The lithium-ion battery was placed in a 45° C. constant-temperature test chamber and left standing for 30 minutes, such that the lithium-ion battery reached a constant temperature. The lithium-ion battery was charged to 4.5 V at a constant current of 0.5 C, then charged at a constant voltage of 4.5 V until the current was 0.025 C, left standing for 5 minutes, and discharged to 3.0 V at a constant current of 0.5 C. A discharge capacity at this point was recorded as an initial discharge capacity C0. This step was cycled 100 times. A discharge capacity after 100 cycles was recorded as C1. A cycling capacity retention rate of the lithium-ion battery was calculated. Cycling capacity retention rate=C1/C0×100%.

The lithium-ion batteries of the following examples or comparative examples differed from Example 1-1 only in: the type and the value of the mass percentage A of the compound of Formula I in the non-aqueous electrolyte and the type of the M element and the value of z in the lithium-containing transition metal composite oxide were adjusted according to Table 1, where when the value of z was adjusted, lithium-containing transition metal composite oxides with different numbers of sodium atoms were used as raw materials, x and y were controlled to satisfy 0.6<x<0.95 and 0≤y<0.15, respectively. The performance test results of the lithium-ion batteries of the examples and the comparative examples are shown in Table 1 below.

TABLE 1

| | | | | | | | Low- |
|---|---|---|---|---|---|---|---|
| | | | | | | High- | temperature |
| | | | | | | temperature | discharge |
| | | | | | | storage | capacity |
| | Compound of | | | | | swelling | retention |
| Item | Formula I | M | A | z | A/z | rate (%) | rate (%) |
| Example 1-1 | Formula I-1 | Al | 0.1 | 0.01 | 10 | 33 | 66 |
| Example 1-2 | Formula I-1 | Al | 0.5 | 0.01 | 50 | 35 | 68 |
| Example 1-3 | Formula I-1 | Al | 1 | 0.01 | 100 | 34 | 67 |
| Example 1-4 | Formula I-1 | Al | 2.5 | 0.02 | 125 | 37 | 62 |
| Example 1-5 | Formula I-1 | Al | 3 | 0.02 | 150 | 38 | 62 |
| Example 1-6 | Formula I-1 | Al | 4.5 | 0.03 | 150 | 40 | 61 |
| Example 1-7 | Formula I-1 | Al | 5 | 0.03 | 167 | 39 | 60 |
| Example 1-8 | Formula I-1 | Al | 6 | 0.03 | 200 | 42 | 59 |
| Example 1-9 | Formula I-1 | Al | 3 | 0.03 | 100 | 42 | 61 |
| Example 1-10 | Formula I-1 | Al | 1.5 | 0.03 | 50 | 41 | 60 |
| Example 1-11 | Formula I-1 | Al | 0.3 | 0.03 | 10 | 40 | 58 |
| Example 1-12 | Formula I-1 | Al | 0.1 | 0.02 | 5 | 36 | 63 |
| Example 1-13 | Formula I-1 | Al | 0.03 | 0.03 | 1 | 40 | 57 |
| Example 1-14 | Formula I-1 | Al | 1 | 0.02 | 50 | 35 | 64 |
| Example 1-15 | Formula I-2 | Al | 1 | 0.02 | 50 | 35 | 68 |
| Example 1-16 | Formula I-3 | Al | 1 | 0.02 | 50 | 34 | 68 |
| Example 1-17 | Formula I-5 | Al | 1 | 0.02 | 50 | 35 | 69 |
| Example 1-18 | Formula I-7 | Al | 1 | 0.02 | 50 | 35 | 67 |
| Example 1-19 | Formula I-10 | Al | 1 | 0.02 | 50 | 35 | 69 |
| Example 1-20 | Formula I-1 | Mn | 1 | 0.02 | 50 | 34 | 63 |
| Example 1-21 | Formula I-1 | Fe | 1 | 0.02 | 50 | 36 | 64 |
| Example 1-22 | Formula I-1 | Ni | 1 | 0.02 | 50 | 34 | 65 |
| Example 1-23 | Formula I-1 | Zn | 1 | 0.02 | 50 | 36 | 63 |
| Example 1-24 | Formula I-1 | Cu | 1 | 0.02 | 50 | 35 | 63 |
| Example 1-25 | Formula I-1 | Ti | 1 | 0.02 | 50 | 36 | 64 |
| Example 1-26 | Formula I-1 | Al | 1 | 0.005 | 200 | 41 | 58 |
| Comparative | / | Al | / | 0.02 | / | 45 | 50 |
| Example 1-1 | | | | | | | |
| Comparative | Formula I-1 | Al | 2 | / | / | 48 | 52 |
| Example 1-2 | | | | | | | |
| Comparative | Formula I-1 | Al | 0.01 | 0.02 | 0.5 | 46 | 51 |
| Example 1-3 | | | | | | | |
| Comparative | Formula I-1 | Al | 7.5 | 0.03 | 250 | 45 | 53 |
| Example 1-4 | | | | | | | |
| Comparative | Formula I-1 | Al | 1 | 0.002 | 500 | 46 | 52 |
| Example 1-5 | | | | | | | |
| Comparative | Formula I-1 | Al | 1 | 0.04 | 25 | 48 | 51 |
| Example 1-6 | | | | | | | |

In the table above, “/” indicates the absence of the substance. M represents the type of the M element. A represents the value of the mass percentage A % of the compound of Formula I based on the mass of the electrolyte, and z represents the value of z in the lithium-containing transition metal composite oxide.

From Table 1, it can be seen that in the lithium-containing transition metal composite oxide LiₓNa_{z}Co_{1-y}M_{y}O₂ of the lithium-ion battery prepared in each of the examples of this application, the value of z satisfies 0<z≤0.03. The mass percentage A % of the compound of Formula I satisfies 1≤A/z≤200. This can improve the low-temperature discharge performance of the lithium-ion battery and facilitate the improvement in the stability of the positive electrode material layer under high-temperature conditions, allowing the lithium-ion battery to have excellent high-temperature storage performance. When at least one of the following conditions is met: (1) 5≤A/z≤100; (2) 0.1≤A≤5; or (3) 0.005≤z≤0.02, the low-temperature discharge capacity retention rate of the lithium-ion battery can be further improved, and the high-temperature storage swelling rate of the lithium-ion battery is reduced.

The lithium-ion batteries of Examples 2-1 to 2-28 differ from the lithium-ion battery of Example 1-5 only in the addition of specific types and percentages of a dinitrile compound and a trinitrile compound during electrolyte preparation. The lithium-ion batteries of Examples 2-29 to 2-34 differ from the lithium-ion battery of Example 1-5 only in the addition of specific types and percentages of a dinitrile compound and a trinitrile compound and the adjustment of the value of the mass percentage A % of the compound of Formula I during electrolyte preparation. The mass percentages of the compound of Formula I, the dinitrile compound, and the trinitrile compound in the electrolyte are shown in Table 2, and the performance test results of the lithium-ion batteries of the examples are shown in Table 2 below.

TABLE 2

| | | | | | | | | | Low- |
|---|---|---|---|---|---|---|---|---|---|
| | | | | | | | | High- | temperature |
| | | | | | | | | temperature | discharge |
| | | | | | | | | storage | capacity |
| | Compound of | | | Compound of | | | | swelling | retention |
| Item | Formula II | A | B | Formula III | C | B + C | A/(B + C) | rate (%) | rate (%) |
| Example 1-5 | / | / | / | / | / | / | / | 38 | 62 |
| Example 2-1 | Succinonitrile | 3 | 1 | 1,3,6-hexanetrinitrile | 1 | 2 | 1.50 | 30 | 77 |
| Example 2-2 | Glutaronitrile | 3 | 1 | 1,3,6-hexanetrinitrile | 1 | 2 | 1.50 | 28 | 77 |
| Example 2-3 | Methyl | 3 | 1 | 1,3,6-hexanetrinitrile | 1 | 2 | 1.50 | 27 | 78 |
| | glutaronitrile | | | | | | | | |
| Example 2-4 | Adiponitrile | 3 | 1 | 1,3,6-hexanetrinitrile | 1 | 2 | 1.50 | 29 | 75 |
| Example 2-5 | Suberonitrile | 3 | 1 | 1,3,6-hexanetrinitrile | 1 | 2 | 1.50 | 30 | 79 |
| Example 2-6 | 1,2- | 3 | 1 | 1,3,6-hexanetrinitrile | 1 | 2 | 1.50 | 29 | 76 |
| | bis(cyanoethoxy) | | | | | | | | |
| | ethane | | | | | | | | |
| Example 2-7 | Methyl | 3 | 1 | 1,3,5-pentanetrinitrile | 1 | 2 | 1.50 | 27 | 74 |
| | glutaronitrile | | | | | | | | |
| Example 2-8 | Methyl | 3 | 1 | 1,2,3-tris(2- | 1 | 2 | 1.50 | 28 | 74 |
| | glutaronitrile | | | cyanoethoxy)propane | | | | | |
| Example 2-9 | Methyl | 3 | 0.05 | 1,3,6-hexanetrinitrile | 1 | 1.05 | 2.86 | 34 | 72 |
| | glutaronitrile | | | | | | | | |
| Example 2-10 | Methyl | 3 | 0.1 | 1,3,6-hexanetrinitrile | 1 | 1.1 | 2.73 | 34 | 71 |
| | glutaronitrile | | | | | | | | |
| Example 2-11 | Methyl | 3 | 0.5 | 1,3,6-hexanetrinitrile | 1 | 1.5 | 2.00 | 31 | 74 |
| | glutaronitrile | | | | | | | | |
| Example 2-12 | Methyl | 3 | 2 | 1,3,6-hexanetrinitrile | 1 | 3 | 1.00 | 27 | 78 |
| | glutaronitrile | | | | | | | | |
| Example 2-13 | Methyl | 3 | 4 | 1,3,6-hexanetrinitrile | 1 | 5 | 0.60 | 25 | 74 |
| | glutaronitrile | | | | | | | | |
| Example 2-14 | Methyl | 3 | 6 | 1,3,6-hexanetrinitrile | 1 | 7 | 0.43 | 30 | 78 |
| | glutaronitrile | | | | | | | | |
| Example 2-15 | Methyl | 3 | 8 | 1,3,6-hexanetrinitrile | 1 | 9 | 0.33 | 35 | 72 |
| | glutaronitrile | | | | | | | | |
| Example 2-16 | Methyl | 3 | 1 | 1,3,6-hexanetrinitrile | 0.05 | 1.05 | 2.86 | 34 | 71 |
| | glutaronitrile | | | | | | | | |
| Example 2-17 | Methyl | 3 | 1 | 1,3,6-hexanetrinitrile | 0.1 | 1.1 | 2.73 | 32 | 73 |
| | glutaronitrile | | | | | | | | |
| Example 2-18 | Methyl | 3 | 1 | 1,3,6-hexanetrinitrile | 0.5 | 1.5 | 2.00 | 29 | 77 |
| | glutaronitrile | | | | | | | | |
| Example 2-19 | Methyl | 3 | 1 | 1,3,6-hexanetrinitrile | 2 | 3 | 1.00 | 26 | 76 |
| | glutaronitrile | | | | | | | | |
| Example 2-20 | Methyl | 3 | 1 | 1,3,6-hexanetrinitrile | 4 | 5 | 0.60 | 27 | 79 |
| | glutaronitrile | | | | | | | | |
| Example 2-21 | Methyl | 3 | 1 | 1,3,6-hexanetrinitrile | 6 | 7 | 0.43 | 29 | 75 |
| | glutaronitrile | | | | | | | | |
| Example 2-22 | Methyl | 3 | 1 | 1,3,6-Hexanetrinitrile | 8 | 9 | 0.33 | 33 | 73 |
| | glutaronitrile | | | | | | | | |
| Example 2-23 | Methyl | 3 | 0.1 | 1,3,6-hexanetrinitrile | 0.1 | 0.2 | 15.00 | 33 | 72 |
| | glutaronitrile | | | | | | | | |
| Example 2-24 | Methyl | 3 | 0.2 | 1,3,6-hexanetrinitrile | 0.3 | 0.5 | 6.00 | 35 | 73 |
| | glutaronitrile | | | | | | | | |
| Example 2-25 | Methyl | 3 | 0.5 | 1,3,6-hexanetrinitrile | 0.5 | 1 | 3.00 | 35 | 73 |
| | glutaronitrile | | | | | | | | |
| Example 2-26 | Methyl | 3 | 2 | 1,3,6-hexanetrinitrile | 2 | 4 | 0.75 | 25 | 75 |
| | glutaronitrile | | | | | | | | |
| Example 2-27 | Methyl | 3 | 4 | 1,3,6-hexanetrinitrile | 4 | 8 | 0.38 | 28 | 76 |
| | glutaronitrile | | | | | | | | |
| Example 2-28 | Methyl | 3 | 5 | 1,3,6-hexanetrinitrile | 5 | 10 | 0.3 | 33 | 71 |
| | glutaronitrile | | | | | | | | |
| Example 2-29 | Methyl | 5 | 0.05 | 1,3,6-hexanetrinitrile | 0.05 | 0.1 | 50 | 34 | 70 |
| | glutaronitrile | | | | | | | | |
| Example 2-30 | Methyl | 4 | 1 | 1,3,6-hexanetrinitrile | 1 | 2 | 2.00 | 30 | 78 |
| | glutaronitrile | | | | | | | | |
| Example 2-31 | Methyl | 1 | 1 | 1,3,6-hexanetrinitrile | 1 | 2 | 0.50 | 27 | 79 |
| | glutaronitrile | | | | | | | | |
| Example 2-32 | Methyl | 0.5 | 1 | 1,3,6-hexanetrinitrile | 1 | 2 | 0.25 | 26 | 75 |
| | glutaronitrile | | | | | | | | |
| Example 2-33 | Methyl | 0.2 | 1 | 1,3,6-hexanetrinitrile | 1 | 2 | 0.10 | 26 | 76 |
| | glutaronitrile | | | | | | | | |
| Example 2-34 | Methyl | 0.1 | 1 | 1,3,6-hexanetrinitrile | 1 | 2 | 0.05 | 35 | 70 |
| | glutaronitrile | | | | | | | | |

In the table above, “/” indicates the absence of the substance. Based on the mass of the electrolyte, A represents the value of the mass percentage A % of the compound of Formula I, B represents the value of the mass percentage B % of the compound of Formula II, and C represents the value of the mass percentage C % of the compound of Formula III.

From Table 2, it can be seen that when the non-aqueous electrolyte of the lithium-ion battery prepared in each of the examples of this application further includes a compound of Formula II and a compound of Formula III, and 0.05≤A/(B+C)≤50 is satisfied, the high-temperature storage swelling rate of the lithium-ion battery can be further reduced, and the low-temperature discharge capacity retention rate of the lithium-ion battery can be further improved. In particular, when the percentage relationship of the compound of Formula I, the compound of Formula II, and the compound of Formula III in the electrolyte is adjusted to satisfy any one of the following conditions: (1) 0.5≤B+C≤8; (2) 0.1≤A/(B+C)≤2; (3) 0.1≤B≤6; or (4) 0.1≤C≤6, the effects of reducing the high-temperature storage swelling rate of the lithium-ion battery and improving the low-temperature discharge capacity retention rate of the lithium-ion battery are more significant.

The lithium-ion batteries of Examples 3-1 to 3-40 are adjusted based on the parameters of the lithium-ion battery of Example 1-5; the lithium-ion battery of Example 3-41 is adjusted based on the parameters of the lithium-ion battery of Example 2-30. The specific adjustment is as follows: during electrolyte preparation, specific types and percentages of the cyclic carbonate, the fluorinated linear ester, the non-fluorinated linear ester, the compound of Formula IV, and the compound of Formula V are added, and the mass percentages of these substances in the electrolyte are shown in Table 3. The performance test results of the lithium-ion batteries of the examples are shown in Table 3 below.

TABLE 3

| | Cyclic carbonate | | | | | Linear ester | | | | |
|---|---|---|---|---|---|---|---|---|---|---|
| | | | | | Total | | | | | Total |
| | | Percentage | | Percentage | percentage | | Percentage | | Percentage | percentage |
| Item | Type | (%) | Type | (%) | (%) | Type | (%) | Type | (%) | (%) |
| Example 1-5 | / | / | / | / | / | / | / | / | / | / |
| Example 3-1 | PC | 1 | FEC | 1 | 2 | / | / | / | / | / |
| Example 3-2 | FEC | 1 | EC | 1 | 2 | / | / | / | / | / |
| Example 3-3 | EC | 1 | PC | 1 | 2 | / | / | / | / | / |
| Example 3-4 | PC | 0.5 | FEC | 0.5 | 1 | / | / | / | / | / |
| Example 3-5 | PC | 4 | FEC | 5 | 9 | / | / | / | / | / |
| Example 3-6 | PC | 7 | FEC | 8 | 15 | / | / | / | / | / |
| Example 3-7 | PC | 11 | FEC | 11 | 22 | / | / | / | / | / |
| Example 3-8 | PC | 15 | FEC | 15 | 30 | / | / | / | / | / |
| Example 3-9 | / | / | / | / | / | Methyl | 15 | / | / | 15 |
| | | | | | | difluoroethyl | | | | |
| | | | | | | carbonate | | | | |
| Example 3-10 | / | / | / | / | / | Hexafluoroisopropyl | 15 | / | / | 15 |
| | | | | | | propionate | | | | |
| Example 3-11 | / | / | / | / | / | 2,2,2-trifluoroethyl | 15 | / | / | 15 |
| | | | | | | propionate | | | | |
| Example 3-12 | / | / | / | / | / | 2,2-difluoroethyl | 10 | / | / | 10 |
| | | | | | | acetate | | | | |
| Example 3-13 | / | / | / | / | / | 2,2-difluoroethyl | 15 | / | / | 15 |
| | | | | | | acetate | | | | |
| Example 3-14 | / | / | / | / | / | 2,2-difluoroethyl | 25 | / | / | 25 |
| | | | | | | acetate | | | | |
| Example 3-15 | / | / | / | / | / | 2,2-difluoroethyl | 50 | / | / | 50 |
| | | | | | | acetate | | | | |
| Example 3-16 | / | / | / | / | / | 2,2-difluoroethyl | 15 | Propyl | 15 | 30 |
| | | | | | | acetate | | propionate | | |
| Example 3-17 | / | / | / | / | / | 2,2-difluoroethyl | 50 | Propyl | 20 | 70 |
| | | | | | | acetate | | propionate | | |
| Example 3-18 | / | / | / | / | / | / | / | Dimethyl | 15 | 15 |
| | | | | | | | | carbonate | | |
| Example 3-19 | / | / | / | / | / | / | / | Ethyl | 15 | 15 |
| | | | | | | | | methyl | | |
| | | | | | | | | carbonate | | |
| Example 3-20 | / | / | / | / | / | / | / | Ethyl | 15 | 15 |
| | | | | | | | | propionate | | |
| Example 3-21 | / | / | / | / | / | / | / | Propyl | 10 | 10 |
| | | | | | | | | propionate | | |
| Example 3-22 | / | / | / | / | / | / | / | Propyl | 15 | 15 |
| | | | | | | | | propionate | | |
| Example 3-23 | / | / | / | / | / | / | / | Propyl | 25 | 25 |
| | | | | | | | | propionate | | |
| Example 3-24 | / | / | / | / | / | / | / | Propyl | 50 | 50 |
| | | | | | | | | propionate | | |
| Example 3-25 | / | / | / | / | / | / | / | / | / | / |
| Example 3-26 | / | / | / | / | / | / | / | / | / | / |
| Example 3-27 | / | / | / | / | / | / | / | / | / | / |
| Example 3-28 | / | / | / | / | / | / | / | / | / | / |
| Example 3-29 | / | / | / | / | / | / | / | / | / | / |
| Example 3-30 | / | / | / | / | / | / | / | / | / | / |
| Example 3-31 | / | / | / | / | / | / | / | / | / | / |
| Example 3-32 | / | / | / | / | / | / | / | / | / | / |
| Example 3-33 | / | / | / | / | / | / | / | / | / | / |
| Example 3-34 | / | / | / | / | / | / | / | / | / | / |
| Example 3-35 | / | / | / | / | / | / | / | / | / | / |
| Example 3-36 | / | / | / | / | / | / | / | / | / | / |
| Example 3-37 | / | / | / | / | / | / | / | / | / | / |
| Example 3-38 | / | / | / | / | / | / | / | / | / | / |
| Example 3-39 | / | / | / | / | / | / | / | / | / | / |
| Example 3-40 | PC | 5 | FEC | 5 | 10 | 2,2-difluoroethyl | 50 | / | / | 50 |
| | | | | | | acetate | | | | |
| Example 3-41 | PC | 5 | FEC | 5 | 10 | 2,2-difluoroethyl | 50 | / | / | 50 |
| | | | | | | acetate | | | | |

| | | | | | | | Low- | |
|---|---|---|---|---|---|---|---|---|
| | | | | | | High- | temperature | |
| | Zwitterionic substance | | | | | temperature | discharge | Cycling |
| | | | | | Total | storage | capacity | capacity |
| | | Percentage | | Percentage | percentage | swelling | retention | retention |
| Item | Type | (%) | Type | (%) | (%) | rate (%) | rate (%) | rate (%) |
| Example 1-5 | / | / | / | / | / | 38 | 62 | 65 |
| Example 3-1 | / | / | / | / | / | 27 | 79 | 72 |
| Example 3-2 | / | / | / | / | / | 31 | 77 | 74 |
| Example 3-3 | / | / | / | / | / | 31 | 78 | 73 |
| Example 3-4 | / | / | / | / | / | 35 | 71 | 69 |
| Example 3-5 | / | / | / | / | / | 29 | 78 | 76 |
| Example 3-6 | / | / | / | / | / | 30 | 75 | 79 |
| Example 3-7 | / | / | / | / | / | 33 | 73 | 69 |
| Example 3-8 | / | / | / | / | / | 35 | 70 | 68 |
| Example 3-9 | / | / | / | / | / | 30 | 78 | 70 |
| Example 3-10 | / | / | / | / | / | 30 | 76 | 73 |
| Example 3-11 | / | / | / | / | / | 30 | 79 | 72 |
| Example 3-12 | / | / | / | / | / | 34 | 72 | 67 |
| Example 3-13 | / | / | / | / | / | 31 | 74 | 73 |
| Example 3-14 | / | / | / | / | / | 26 | 74 | 71 |
| Example 3-15 | / | / | / | / | / | 31 | 75 | 79 |
| Example 3-16 | / | / | / | / | / | 25 | 78 | 79 |
| Example 3-17 | / | / | / | / | / | 35 | 70 | 68 |
| Example 3-18 | / | / | / | / | / | 31 | 79 | 70 |
| Example 3-19 | / | / | / | / | / | 31 | 78 | 70 |
| Example 3-20 | / | / | / | / | / | 31 | 79 | 70 |
| Example 3-21 | / | / | / | / | / | 34 | 71 | 68 |
| Example 3-22 | / | / | / | / | / | 28 | 77 | 73 |
| Example 3-23 | / | / | / | / | / | 31 | 79 | 72 |
| Example 3-24 | / | / | / | / | / | 31 | 78 | 70 |
| Example 3-25 | Formula IV-1 | 0.5 | / | / | 0.5 | 30 | 76 | 70 |
| Example 3-26 | Formula IV-3 | 0.5 | / | / | 0.5 | 31 | 74 | 70 |
| Example 3-27 | Formula IV-5 | 0.5 | / | / | 0.5 | 28 | 75 | 71 |
| Example 3-28 | / | / | Formula V-1 | 0.5 | 0.5 | 30 | 77 | 70 |
| Example 3-29 | / | / | Formula V-2 | 0.5 | 0.5 | 29 | 75 | 72 |
| Example 3-30 | / | / | Formula V-4 | 0.5 | 0.5 | 30 | 76 | 71 |
| Example 3-31 | Formula IV-1 | 0.25 | Formula V-3 | 0.25 | 0.5 | 29 | 74 | 71 |
| Example 3-32 | Formula IV-4 | 0.25 | Formula V-1 | 0.25 | 0.5 | 31 | 75 | 70 |
| Example 3-33 | Formula IV-5 | 0.25 | Formula V-5 | 0.25 | 0.5 | 30 | 77 | 70 |
| Example 3-34 | / | / | Formula V-5 | 0.1 | 0.1 | 35 | 72 | 66 |
| Example 3-35 | / | / | Formula V-5 | 0.3 | 0.3 | 31 | 77 | 70 |
| Example 3-36 | / | / | Formula V-5 | 0.4 | 0.4 | 30 | 77 | 70 |
| Example 3-37 | / | / | Formula V-5 | 0.5 | 0.5 | 29 | 76 | 73 |
| Example 3-38 | / | / | Formula V-5 | 0.8 | 0.8 | 28 | 75 | 70 |
| Example 3-39 | / | / | Formula V-5 | 1 | 1 | 34 | 70 | 68 |
| Example 3-40 | / | / | Formula V-5 | 0.4 | 0.4 | 23 | 80 | 89 |
| Example 3-41 | / | / | Formula V-5 | 0.4 | 0.4 | 19 | 81 | 90 |

In the table above, “/” indicates the absence of the substance. All percentages are based on the mass of the electrolyte, and the codes correspond to the following compounds:

EC: ethylene carbonate; PC: propylene carbonate; and FEC: fluoroethylene carbonate.

From Table 3, it can be seen that when the non-aqueous electrolyte of the lithium-ion battery prepared in each of the examples of this application further includes the cyclic carbonate, linear ester, or zwitterionic substance, the cycling capacity retention rate of the lithium-ion battery can be further improved, the high-temperature storage swelling rate is reduced, and the low-temperature discharge capacity retention rate is improved. In particular, when the mass percentage of the cyclic carbonate is 2% to 15%, the cycling capacity retention rate of the lithium-ion battery can be significantly improved, the high-temperature storage swelling rate is reduced, and the low-temperature discharge capacity retention rate is improved. In particular, when the mass percentage of the linear ester is 15% to 50%, the cycling capacity retention rate of the lithium-ion battery can be significantly improved, the high-temperature storage swelling rate is reduced, and the low-temperature discharge capacity retention rate is improved. In particular, when a total mass percentage of the compound of Formula IV and the compound of Formula V as the zwitterionic substance is 0.1% to 1%, the cycling capacity retention rate of the lithium-ion battery can be significantly improved, the high-temperature storage swelling rate is reduced, and the low-temperature discharge capacity retention rate is improved.

The foregoing descriptions are merely preferred embodiments of this application, and are not intended to limit this application. Any modifications, equivalent replacements, improvements, and the like made without departing from the principle of this application shall fall within the protection scope of this application.

What is claimed is:

1. An electrochemical apparatus, comprising a positive electrode and a non-aqueous electrolyte, wherein the positive electrode comprises a positive electrode material layer disposed on at least one surface of a positive electrode current collector; the positive electrode material layer comprises a lithium-containing transition metal composite oxide, and the lithium-containing transition metal composite oxide comprises LiₓNa_{z}Co_{1-y}MyO₂, wherein 0.6<x<0.95, 0≤y<0.15, 0<z≤0.03, and M is at least one selected from the group consisting of Al, Mg, Ti, Mn, Fe, Ni, Zn, Cu, Nb, Cr, and Zr; and the non-aqueous electrolyte comprises a compound of Formula I: 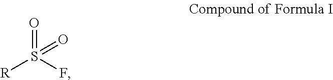
wherein R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, and substituents Ra of the groups are independently selected from fluorine or a C₁ to C₆ fluoroalkyl group; and
based on a total mass of the non-aqueous electrolyte, a mass percentage of the compound of Formula I is A %, and 1≤A/z≤200.

2. The electrochemical apparatus according to claim 1, wherein the electrochemical apparatus satisfies at least one of the following conditions:
$$5 \leq A / z \leq 100 ; \qquad ( 1 )$$
$$0.1 \leq A \leq 5 ; or \qquad ( 2 )$$
$$0.005 \leq z \leq 0.02 . \qquad ( 3 )$$

3. The electrochemical apparatus according to claim 1, wherein the compound of Formula I comprises at least one of the following compounds:

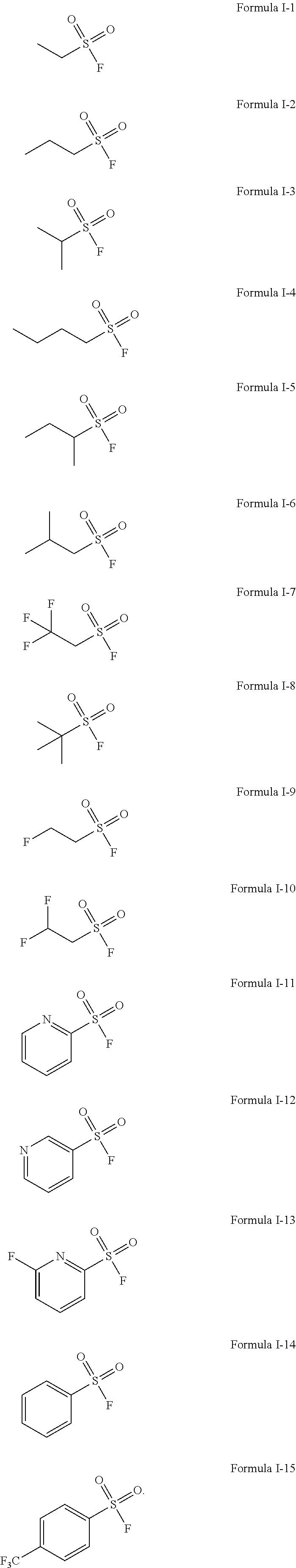

4. The electrochemical apparatus according to claim 1, wherein the non-aqueous electrolyte further comprises a compound of Formula II and a compound of Formula III: 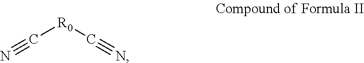
wherein R₀ is selected from a C₂ to C₁₀ chain alkylene group, a C₂ to C₁₀ alkenylene group, or —Rₐ—(O—R_{b})ₙ—R_{c}—, and Rₐ, R_{b}, and R_{c} are each independently selected from a C₁ to C₃ alkylene group or a C₂ to C₃ alkenylene group, and n is an integer from 1 to 3; and 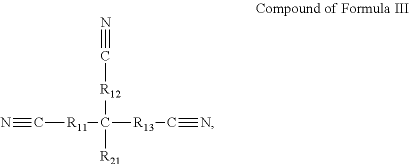
wherein R₁₁, R₁₂, and R₁₃ are each independently selected from a C₁ to C₃ alkylene group or —R_{A}—(O—R_{B})ₙ—R_{C}—, R_{A}, R_{B}, and R_{C} are each independently selected from a single bond or a C₁ to C₂ alkylene group, n is an integer from 1 to 3, and R₂₁ is selected from a hydrogen atom or a C1 to C₃ alkylene group; wherein
based on the total mass of the non-aqueous electrolyte, a mass percentage of the compound of Formula II is B %, a mass percentage of the compound of Formula III is C %, and 0.05≤A/(B+C)≤50.

5. The electrochemical apparatus according to claim 4, wherein the non-aqueous electrolyte satisfies at least one of the following conditions:
$$0.5 \leq B + C \leq 8 ; \qquad ( 1 )$$
$$0.1 \leq A / ( B + C ) \leq 2 ; \qquad ( 2 )$$
$$0.1 \leq B \leq 6 ; or \qquad ( 3 )$$
$$0.1 \leq C \leq 6. \qquad ( 4 )$$

6. The electrochemical apparatus according to claim 4, wherein the compound of Formula II is at least one selected from succinonitrile, glutaronitrile, methyl glutaronitrile, adiponitrile, pimelonitrile, suberonitrile, trans-butenedinitrile, or 1,2-bis(cyanoethoxy)ethane; and/or
the compound of Formula III is at least one selected from 1,3,5-pentanetrinitrile, 1,3,6-hexanetrinitrile, or 1,2,3-tris(2-cyanoethoxy)propane.

7. The electrochemical apparatus according to claim 1, wherein the non-aqueous electrolyte further comprises a cyclic carbonate; the cyclic carbonate includes at least two selected from ethylene carbonate, propylene carbonate, or fluoroethylene carbonate; and based on the total mass of the non-aqueous electrolyte, a mass percentage of the cyclic carbonate is 1% to 30%.

8. The electrochemical apparatus according to claim 7, wherein based on the total mass of the non-aqueous electrolyte, the mass percentage of the cyclic carbonate is 2% to 15%.

9. The electrochemical apparatus according to claim 1, wherein the non-aqueous electrolyte further comprises a linear ester; the linear ester comprises a fluorinated linear ester and a non-fluorinated linear ester; and the linear ester satisfies at least one of the following conditions:
(1) the fluorinated linear ester is at least one selected from methyl difluoroethyl carbonate, methyl trifluoroethyl carbonate, ethyl trifluoroethyl carbonate, methyl hexafluoroisopropyl carbonate, bis(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate;
(2) the non-fluorinated linear ester is at least one selected from dimethyl carbonate, ethyl methyl carbonate, methyl propyl carbonate, ethyl propyl carbonate, methyl acetate, ethyl acetate, propyl acetate, methyl propionate, ethyl propionate, or propyl propionate; or
(3) based on the total mass of the non-aqueous electrolyte, a mass percentage of the linear ester is X₀%, and 10≤X₀≤70.

10. The electrochemical apparatus according to claim 9, wherein based on the total mass of the non-aqueous electrolyte, the non-aqueous electrolyte satisfies at least one of the following conditions:
(1) a mass percentage of the fluorinated linear ester is X₁%, and 10≤X₁≤50;
(2) a mass percentage of the non-fluorinated linear ester is X₂%, and 5≤X₂≤50; or
(3) 15≤X₀≤50.

11. The electrochemical apparatus according to claim 1, wherein the non-aqueous electrolyte further comprises a compound of Formula IV and/or a compound of Formula V; 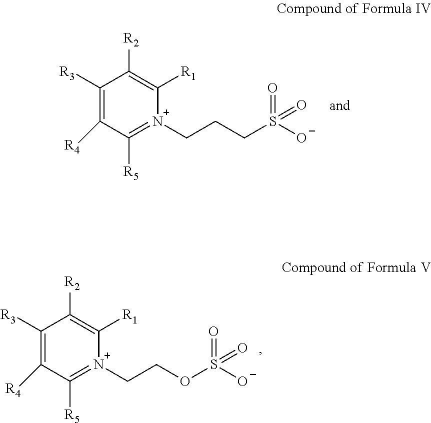
wherein R₁ to R₅are each independently selected from a hydrogen atom, a fluorine atom, a vinyl group, an ethynyl group, or an anhydride group;
based on the total mass of the non-aqueous electrolyte, a total mass percentage of the compound of Formula IV and the compound of Formula V is 0.1% to 1%; and
any two adjacent groups among R₁ to R₅ exist independently or are connected through a covalent bond and connected to a parent ring to form a ring.

12. The electrochemical apparatus according to claim 11, wherein the compound of Formula IV comprises at least one of the following compounds: 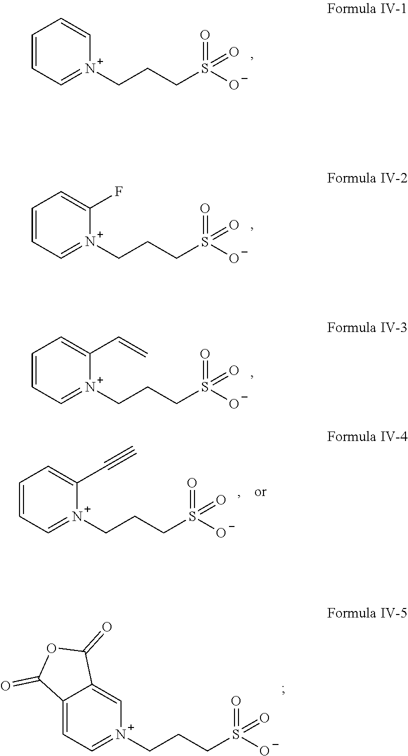 [SMILES: O=S(=O)([O-])CCC[n+]1ccccc1 ; O=S(=O)([O-])CCC[n+]1ccccc1F ; C=Cc1cccc[n+]1CCCS(=O)(=O)[O-] ; C#Cc1cccc[n+]1CCCS(=O)(=O)[O-] ; O=C1OC(=O)c2c[n+](CCCS(=O)(=O)[O-])ccc21]
and/or
the compound of Formula V comprises at least one of the following compounds:

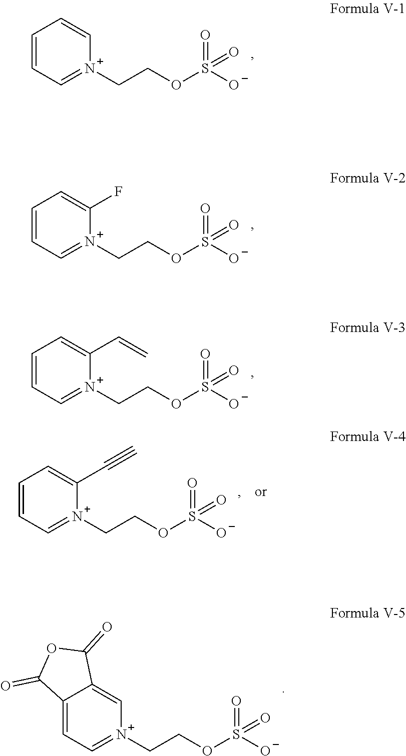 [SMILES: O=S(=O)([O-])OCC[n+]1ccccc1 ; O=S(=O)([O-])OCC[n+]1ccccc1F ; C=Cc1cccc[n+]1CCOS(=O)(=O)[O-] ; C#Cc1cccc[n+]1CCOS(=O)(=O)[O-] ; O=C1OC(=O)c2c[n+](CCOS(=O)(=O)[O-])ccc21]

13. An electronic apparatus, comprising an electrochemical apparatus, the electrochemical apparatus comprises a positive electrode and a non-aqueous electrolyte, wherein the positive electrode comprises a positive electrode material layer disposed on at least one surface of a positive electrode current collector; the positive electrode material layer comprises a lithium-containing transition metal composite oxide, and the lithium-containing transition metal composite oxide comprises LiₓNa_{z}Co_{1-y}M_{y}O₂, wherein 0.6<x<0.95, 0≤y<0.15, 0<z≤0.03, and M is at least one selected from the group consisting of Al, Mg, Ti, Mn, Fe, Ni, Zn, Cu, Nb, Cr, and Zr; and the non-aqueous electrolyte comprises a compound of Formula I: 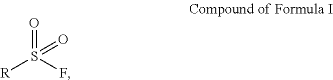
wherein R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, and substituents Ra of the groups are independently selected from fluorine or a C₁ to C₆ fluoroalkyl group; and
based on a total mass of the non-aqueous electrolyte, a mass percentage of the compound of Formula I is A %, and 1≤A/z≤200.

14. The electronic apparatus according to claim 13, wherein the electrochemical apparatus satisfies at least one of the following conditions:
$$5 \leq A / z \leq 100 ; \qquad ( 1 )$$
$$0.1 \leq A \leq 5 ; or \qquad ( 2 )$$
$$0.005 \leq z \leq 0.02 . \qquad ( 3 )$$

15. The electronic apparatus according to claim 13, wherein the compound of Formula I comprises at least one of the following compounds:

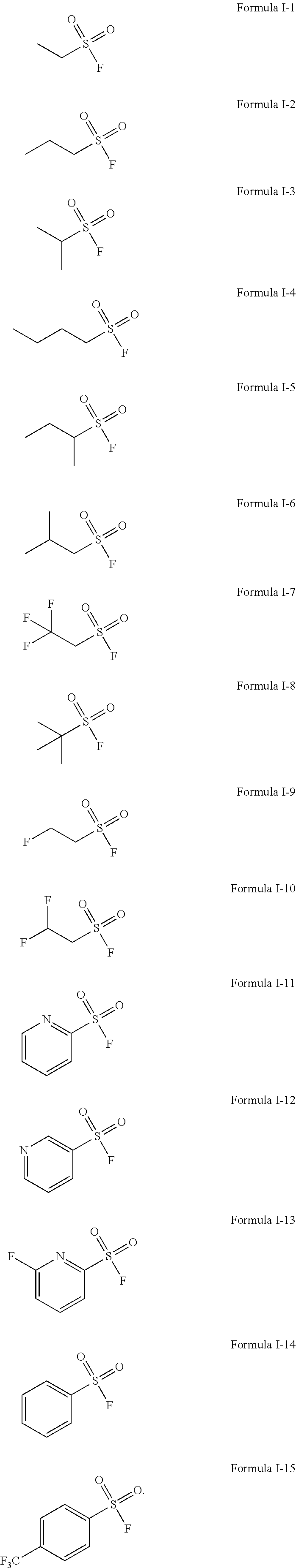

16. The electronic apparatus according to claim 13, wherein the non-aqueous electrolyte further comprises a compound of Formula II and a compound of Formula III: 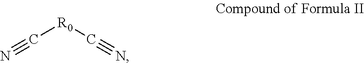
wherein R₀ is selected from a C₂ to C₁₀ chain alkylene group, a C₂ to C₁₀ alkenylene group, or —Rₐ—(O—R_{b})ₙ—R_{c}, and Rₐ, R_{b}, and R_{c} are each independently selected from a C₁ to C₃ alkylene group or a C₂ to C₃ alkenylene group, and n is an integer from 1 to 3; and 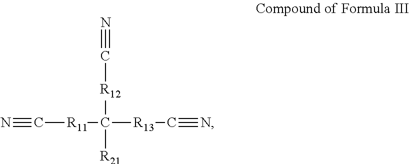
wherein R₁₁, R₁₂, and R₁₃ are each independently selected from a C₁ to C₃ alkylene group or —R_{A}—(O—R_{B})ₙ—R_{C}—, R_{A}, R_{B}, and R_{C} are each independently selected from a single bond or a C₁ to C₂ alkylene group, n is an integer from 1 to 3, and R₂₁ is selected from a hydrogen atom or a C₁ to C₃ alkylene group; wherein
based on the total mass of the non-aqueous electrolyte, a mass percentage of the compound of Formula II is B %, a mass percentage of the compound of Formula III is C %, and 0.05≤A/(B+C)≤50.

17. The electronic apparatus according to claim 16, wherein the non-aqueous electrolyte satisfies at least one of the following conditions:
$$0.5 \leq B + C \leq 8 ; \qquad ( 1 )$$
$$0.1 \leq A / ( B + C ) \leq 2 ; \qquad ( 2 )$$
$$0.1 \leq B \leq 6 ; or \qquad ( 3 )$$
$$0.1 \leq C \leq 6. \qquad ( 4 )$$

18. The electronic apparatus according to claim 16, wherein the compound of Formula II is at least one selected from succinonitrile, glutaronitrile, methyl glutaronitrile, adiponitrile, pimelonitrile, suberonitrile, trans-butenedinitrile, or 1,2-bis(cyanoethoxy)ethane; and/or
the compound of Formula III is at least one selected from 1,3,5-pentanetrinitrile, 1,3,6-hexanetrinitrile, or 1,2,3-tris(2-cyanoethoxy)propane.

19. The electronic apparatus according to claim 13, wherein the non-aqueous electrolyte further comprises a cyclic carbonate; the cyclic carbonate includes at least two selected from ethylene carbonate, propylene carbonate, or fluoroethylene carbonate; and based on the total mass of the non-aqueous electrolyte, a mass percentage of the cyclic carbonate is 1% to 30%.

20. The electronic apparatus according to claim 19, wherein based on the total mass of the non-aqueous electrolyte, the mass percentage of the cyclic carbonate is 2% to 15%.
